(19) United States
(12) Patent Application Publication
(10) Pub. No.: US 2023/0118081 A1
(43) Pub. Date: Apr. 20, 2023

(54) MULTILAYER TRANSMISSION STRUCTURES FOR WAVEGUIDE DISPLAY

(71) Applicant: Applied Materials, Inc., Santa Clara, CA (US)

(72) Inventors: Jianji YANG, Cupertino, CA (US); Samarth BHARGAVA, Saratoga, CA (US); David Alexander SELL, Santa Clara, CA (US); Kevin MESSER, Mountain View, CA (US)

(21) Appl. No.: 17/954,085

(22) Filed: Sep. 27, 2022

Related U.S. Application Data
(60) Provisional application No. 63/256,052, filed on Oct. 15, 2021.

(51) Int. Cl. F21V 8/00; G02B 27/01

(52) U.S. Cl. CPC G02B 6/0016; G02B 6/0038; G02B 6/0065; G02B 27/0172

(57) ABSTRACT

Embodiments of the present disclosure describe waveguides having device structures with multiple portions and methods of forming the waveguide having multiportion device structures. The plurality of device structures are formed having two or more portions. The materials of the plurality of portions are chosen such that impedance matching is enabled between the portions to reduce reflection of light from the optical device.

### CROSS-REFERENCE TO RELATED APPLICATIONS

This application claims priority to U.S. Provisional Patent Application Ser. No. 63/256,052, filed on Oct. 15, 2021, which is herein incorporated by reference.

### BACKGROUND

### Field

Embodiments of the present disclosure generally relate to optical devices for augmented, virtual, and mixed reality. More specifically, embodiments described herein provide for waveguides having device structures with multiple portions and methods of forming the waveguide having multi-portion device structures.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment. Augmented reality, however, enables an experience in which a user can still see through the display lenses of the glasses or other HMD device to view the surrounding environment, yet also see images of virtual objects that are generated to appear as part of the environment. Augmented reality can include any type of input, such as audio and haptic inputs, as well as virtual images, graphics, and video that enhance or augment the environment that the user experiences. As an emerging technology, there are many challenges and design constraints with augmented reality.

One such challenge is displaying a virtual image overlaid on an ambient environment. Optical devices including waveguide combiners, such as augmented reality waveguide combiners are used to assist in overlaying images. Generated light is propagated through an optical device until the light exits the optical device and is overlaid on the ambient environment. However, existing optical devices lack a desired level of coupling efficiency. Accordingly, what is needed in the art are optical devices with improved coupling efficiency.

### SUMMARY

In one embodiment, a waveguide is provided. The waveguide includes an optical device substrate and at least one grating disposed over the optical device substrate. The at least one grating includes a plurality of device structures. Adjacent device structures of the plurality of device structures define a gap therebetween. The plurality of device structures include a device portion. The device portion includes a device material having a first refractive index of about 1.9 to about 4.0. The plurality of device structures include an impedance matching portion. The impedance matching portion includes a second refractive index of about 1.4 to about 2.0.

In another embodiment, a waveguide is provided. The waveguide includes an optical device substrate and at least one grating disposed over the optical device substrate. The at least one grating includes a plurality of device structures. Adjacent device structures of the plurality of device structures define a gap therebetween. The plurality of device structures include a device portion. The device portion includes a device material having a first refractive index of about 1.9 to about 4.0. The plurality of device structures include an impedance matching portion. The impedance matching portion includes a second refractive index of about 1.4 to about 2.0. The plurality of device structures include an anti-reflective portion. The anti-reflective portion includes an anti-reflective refractive index of about 1.4 to about 2.0. A difference between the first refractive index and at least one of the second refractive index or the anti-reflective refractive index is about 0.45 to about 1.15.

In yet another embodiment, a method is provided. The method includes disposing two or more layers of material on a surface of a substrate. The method further includes etching through the two or more layers of material to form a plurality of device structures having two or more portions. The two or more portions include a device portion having a first refractive index of between about 1.9 and about 4.0 and at least one of an impedance matching portion or an anti-reflective portion. The impedance matching portion or the anti-reflective portion include a second refractive index of about 1.4 to about 2.0. A difference between the first refractive index and the second refractive index is about 0.45 to about 1.15.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a schematic, top view of waveguide according to embodiments described herein.

FIGS. 2A-2C are schematic, cross-sectional views of a portion of a waveguide according to embodiments described herein.

FIGS. 3A-3C are schematic, top-views of a portion of a waveguide according to embodiments described herein.

FIG. 4 is a flow diagram of a method for forming device structures having multiple portions of materials according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to optical devices for augmented, virtual, and mixed reality. More specifically, embodiments described herein provide for waveguides having device structures with multiple portions and methods of forming the waveguide having multi-portion device structures.

In one embodiment, a waveguide is provided. The waveguide includes an optical device substrate and at least one grating disposed over the optical device substrate. The at least one grating includes a plurality of device structures. Adjacent device structures of the plurality of device structures define a gap therebetween. The plurality of device structures include a device portion. The device portion includes a device material having a first refractive index of about 1.9 to about 4.0. The plurality of device structures include an impedance matching portion. The impedance matching portion includes a second refractive index of about 1.4 to about 2.0. The plurality of device structures include an anti-reflective portion. The anti-reflective portion includes an anti-reflective refractive index of about 1.4 to about 2.0. A difference between the first refractive index and at least one of the second refractive index or the anti-reflective refractive index is about 0.45 to about 1.15.

In another embodiment, a method is provided. The method includes disposing two or more layers of material on a surface of a substrate. The method further includes etching through the two or more layers of material to form a plurality of device structures having two or more portions. The two or more portions include a device portion having a first refractive index of between about 1.9 and about 4.0 and at least one of an impedance matching portion or an anti-reflective portion. The impedance matching portion or the anti-reflective portion include a second refractive index of about 1.4 to about 2.0. A difference between the first refractive index and the second refractive index is about 0.45 to about 1.15.

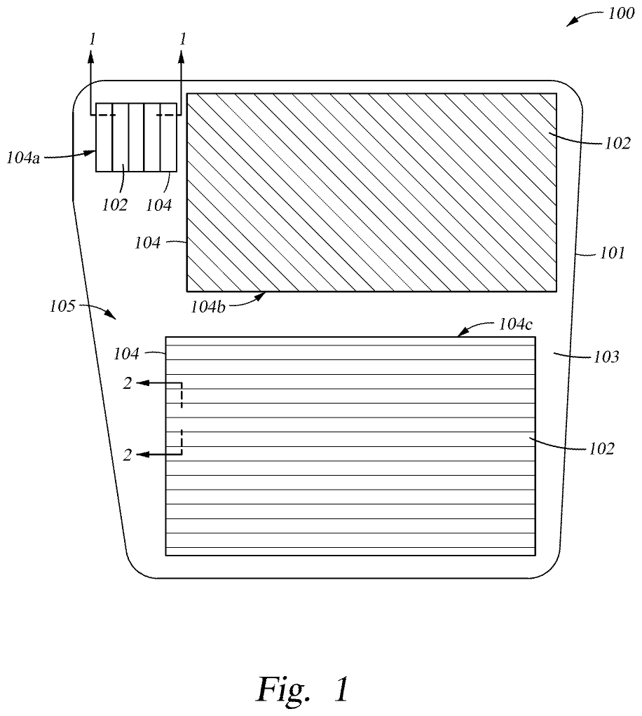

FIG. 1 is a schematic, top view of a waveguide 100. It is to be understood that the waveguide 100 described below is an exemplary optical device. In one embodiment, which can be combined with other embodiments described herein, the waveguide 100 is a waveguide combiner, such as an augmented reality waveguide combiner. The waveguide 100 may additionally be a waveguide utilized for optical sensing (e.g., eye tracking capabilities).

The waveguide 100 includes a plurality of device structures 102 disposed on a top surface 103 of a substrate 101. A portion 105 of the plurality of device structures 102 are shown in FIG. 1. The device structures 102 may be nanostructures having sub-micron dimensions, e.g., nano-sized dimensions. In one embodiment, which can be combined with other embodiments described herein, regions of the device structures 102 correspond to one or more gratings 104, such as a first grating 104A, a second grating 104B, and a third grating 104C. In one embodiment, which can be combined with other embodiments described herein, the waveguide 100 is a waveguide combiner that includes at least the first grating 104A corresponding to an input coupling grating and the third grating 104C corresponding to an output coupling grating. The waveguide combiner, which can be combined with other embodiments described herein, includes the second grating 104B corresponding to an intermediate grating. The substrate 101 may be formed from any suitable material, provided that the substrate 101 can adequately transmit light in a desired wavelength or wavelength range and can serve as an adequate support for the waveguide 100, described herein. In one embodiment, which can be combined with other embodiments described herein, the wavelength range is between about 400 nm to about 2000 nm. Substrate selection may include substrates of any suitable material, including, but not limited to, silicon (Si), silicon dioxide (SiO₂), doped SiO₂, fused silica, quartz, silicon carbide (SiC), germanium (Ge), silicon germanium (SiGe), indium phosphide (InP), gallium arsenide (GaAs), gallium nitride (GaN), diamond, or sapphire containing materials.

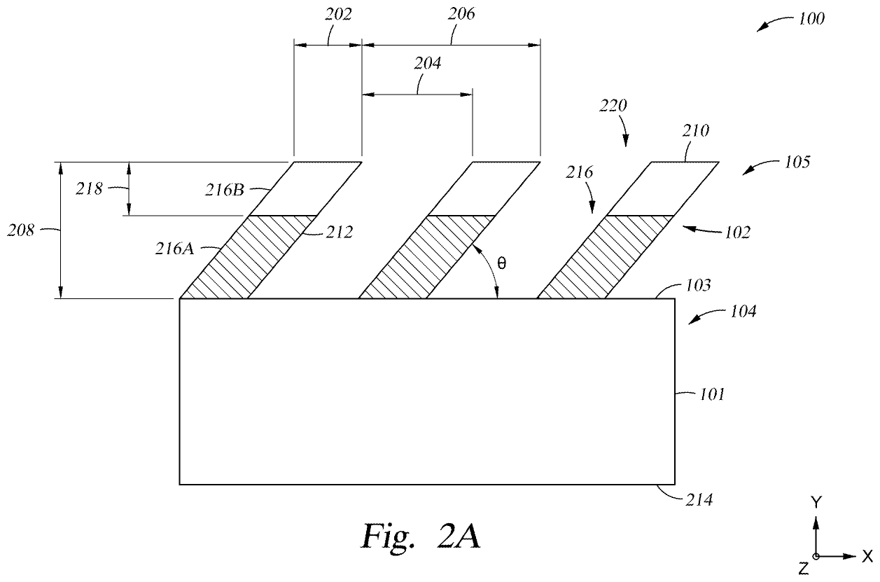

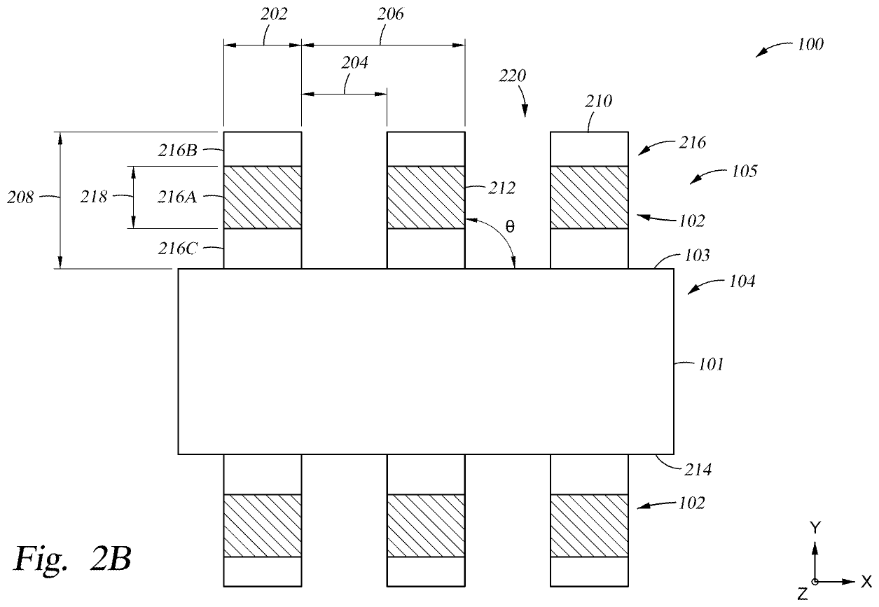

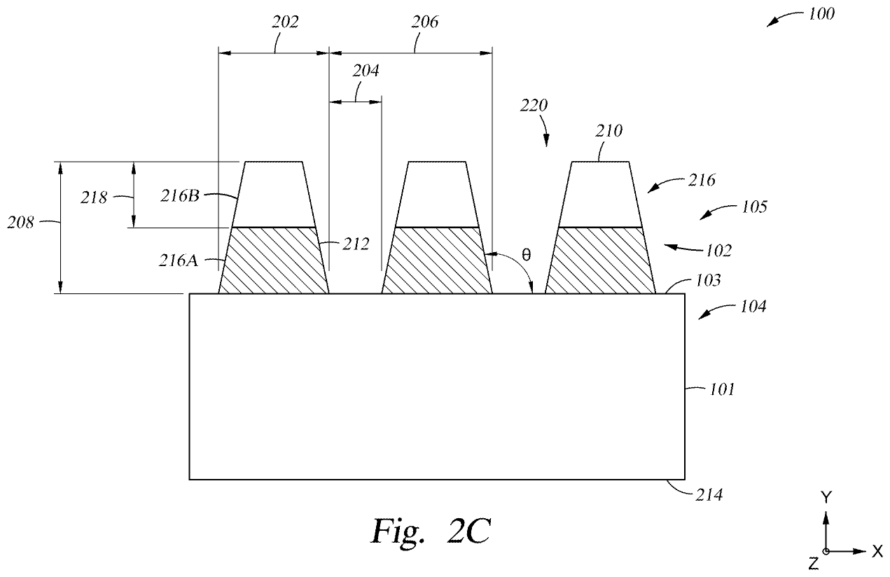

FIGS. 2A-2C are schematic, cross-sectional views of a portion 105 of a grating 104 of a waveguide 100. The grating 104 includes a plurality of device structures 102. FIGS. 2A and 2C are taken along section line 1-1 of FIG. 1, such that the portion 105 of the grating 104 corresponds to a first grating 104A, e.g., an input coupling grating, of the waveguide 100. FIG. 2B is taken along section line 2-2 of FIG. 1, such that the portion 105 corresponds to the third grating 104C, i.e., an output coupling grating. Although FIGS. 2A and 2C show the portion 105 corresponding to the first grating 104a, and FIG. 2B shows the portion 105 corresponding to the third grating 104c, the portion 105 of FIGS. 2A-2C are not limited to the grating 104 and may correspond to any of the first grating 104a, the second grating 104b, or the third grating 104c. The plurality of device structures 102 are disposed on a top surface 103 of a substrate 101. Each of the device structures 102 includes an upper surface 210. The plurality of device structures 102 define a plurality of gaps 220. Each gap of the plurality of gaps 220 is defined between adjacent device structures 102.

Each device structure 102 of the plurality of device structures 102 has a structure width 202. The structure width 202 is defined as the width of the device structure 102 closest to the top surface 103 of the substrate 101. In one embodiment, which can be combined with other embodiments described herein, at least one structure width 202 may be different from another structure width 202. In another embodiment, which can be combined with other embodiments described herein, each structure width 202 of the plurality of device structures 102 is substantially equal to each other structure width 202. Each device structure 102 of the plurality of device structures 102 has a spacewidth 204. The spacewidth 204 is defined as the distance between adjacent device structures 102 closest to the top surface 103 of the substrate 101. In one embodiment, which can be combined with other embodiments described herein, at least one spacewidth 204 may be different from another spacewidth 204. In another embodiment, which can be combined with other embodiments described herein, each spacewidth 204 of the plurality of device structures 102 is substantially equal to each other spacewidth 204. A duty cycle of the waveguide 100 is defined as the ratio of the spacewidth 204 to the structure width 202. In one embodiment, which can be combined with other embodiments described herein, the duty cycle is constant across the substrate 101. In another embodiment, which can be combined with other embodiments described herein, the duty cycle varies across the substrate 101. The duty cycle is between about 5% and about 95%.

A pitch 206 is defined as the summation of the spacewidth 204 and the structure width 202 for each device structure 102. In one embodiment, which can be combined with other embodiments described herein, the pitch 206 is constant across the substrate 101. In another embodiment, which can be combined with other embodiments described herein, the pitch 206 varies across the substrate 101. The pitch 206 is between about 150 nm and about 1500 nm. A depth 208 is defined as the distance between the upper surfaces 210 of each device structure 102 to the top surface 103 of the substrate 101. In one embodiment, which can be combined with other embodiments described herein, the depth 208 is constant across the substrate 101. In another embodiment, which can be combined with other embodiments described herein, the depth 208 varies across the substrate 101. The depth 208 of each device structure 102 is between about 10 nm and about 2000 nm.

The plurality of device structures 102 are formed at a device angle ϑ. The device angle ϑ is the angle between the surface 103 of the substrate 101 and a sidewall 212 of the device structure 102. As shown in FIGS. 2A and 2C, the plurality of device structures 102 are angled relative to the top surface 103 of the substrate 101. The device angle ϑ is between about 10 degrees and about 170 degrees, such as from about 40 degrees to about 140 degrees. For example, the device angle ϑ is from about 70 degrees to about 110 degrees. As shown in FIG. 2B, the plurality of device structures 102 are vertical, i.e., the device angle ϑ is 90 degrees. In one embodiment, which can be combined with other embodiments described herein, each respective device angle ϑ for each device structure 102 is substantially equal. In another embodiment, which can be combined with other embodiments described herein, at least one respective device angle ϑ of the plurality of device structures 102 is different than another device angle ϑ of the plurality of device structures 102.

The plurality of device structures 102 shown in FIGS. 2A-2C may correspond to any one of the first grating 104A, the second grating 104B, or the third grating 104C of the waveguide 100, shown in FIG. 1. As shown in FIG. 2B, the plurality of device structures 102 may be disposed on both the top surface 103 of the substrate 101 and a bottom surface 214 of the substrate 101. In one embodiment, which can be combined with other embodiments described herein, the plurality of device structures 102 are operable to couple light into the substrate 101. In another embodiment, which can be combined with other embodiments described herein, the plurality of device structures 102 are operable to couple light out of the substrate 101 to a user. The light may be coupled out of the top surface 103 and/or the bottom surface 214 of the substrate 101.

Although the plurality of device structures 102 are shown on the top surface 103 of the substrate 101 in FIGS. 2A and 2C, the plurality of device structures 102 may be disposed on the top surface 103 and the bottom surface 214. Although the plurality of device structures 102 are shown on the top surface 103 and the bottom surface 214 in FIG. 2B, the plurality of device structures 102 may be disposed only on one of the top surface 103 or the bottom surface 214.

Each of the plurality of device structures 102 includes a plurality of portions 216 (i.e., portions 216A-216C). For example, each device structure 102 may have two or more portions 216. Each of the plurality of portions 216 includes a thickness 218. The thickness 218 of the plurality of portions 216 is determined to improve the diffraction efficiency of the plurality of device structures 102. For example, the thickness 218 of each of the plurality of portions 216 may be determined to enhance or lower the efficiency of the waveguide 100 for a certain wavelength coupled to the waveguide 100. The ability to enhance or lower the efficiency of specific wavelengths of light coupled into the waveguide 100 (i.e., color balancing) is beneficial for waveguides 100 operable to couple more than one wavelength of light. Each portion 216 of the plurality of portions 216 may have a different thickness 218 or the same thickness 218 as adjacent portions 216.

The plurality of device structures 102 having the plurality of portions 216 improves the light coupling efficiency and image quality of the waveguide 100 due to impedance matching between materials of the portions 216. The plurality of portions 216 enable impedance matching between the portions 216 to adjust reflection of light from the waveguide 100. For example, impedance matching the portions 216 may reduce the light reflection of one wavelength of light, but will intentionally increase the light reflection of another wavelength of light. The plurality of portions 216 increase the coupling efficiency of different wavelengths of light (e.g., colors of light) in a single waveguide 100 (where RGB colors are emitted from the same waveguide 100).

The impedance matching allows for the device structures 102 to couple light from the substrate 101 to the surroundings or couple the incident light to the substrate 101 more efficiently, such that the incident light is angularly uniform, and/or spectrally uniform. The impedance matching between the portions 216 lowers reflections and back-diffracted light. When there is excessive reflections and back-diffraction, some of the reflected light can be coupled into the waveguide 100, causing ghost imaging. Thus, the impedance matching between the portions 216 will reduce the occurrence of ghost imaging and stray light. Additionally, the plurality of portions 216 can improve optical efficiencies for large incident angles, such that the field-of-view FOV may be enlarged. Also, as the plurality of portions 216 are not disposed in the plurality of gaps 220 in-between the plurality of device structures 102, a higher refractive index contrast may occur. The refractive index contrast between the device structures 102 and the plurality of gaps 220 provides a refractive index contrast. It is desirable to have a large contrast between refractive indices of the structure material of the plurality of device structures 102 and the materials surrounding the plurality of device structures 102 to improve the optical performance of the waveguide 100.

In embodiments where the device structures 102 having the plurality of portions 216 are disposed on the third grating 104C, as a result of impedance matching with the multiple portions 216, see through transmission (or light from external world) can be improved. When multiple waveguides 100 are stacked, the plurality of portions 216 lower the occurrence of reflection at each waveguide, so that the user can see more light from outside the waveguide 100. In addition to the benefit for enhancing the see through transmission, the device structures 102 on each waveguide 100 of the stacked waveguides 100 can allow higher light transmission from adjacent waveguides 100 to minimize stray light and improve the overall optical efficiency of the entire waveguide 100.

In some embodiments, which can be combined with other embodiments described herein, the plurality of device structures 102 include two portions 216. For example, the plurality of device structures 102 include a device portion 216A and an impedance matching portion 216B disposed over the device portion 216A, as shown in FIGS. 2A-2C. In other embodiments, which can be combined with other embodiments described herein, the plurality of device structures 102 include an anti-reflective portion 216C disposed below the device portion 216A, as shown in FIG. 2B. Although only three portions 216 are shown in FIG. 2B, the plurality of portions 216 may include more than three portions 216.

The device portion 216A is a high refractive index material. The refractive index of the device portion 216A is between about 1.9 to about 4.0. The device portion 216A includes, but is not limited to, materials such as or containing germanium, silicon, titanium oxide, niobium oxide, silicon nitride, hafnium oxide, tantalum oxide, scandium oxide, or combinations thereof. The impedance matching portion 216B is a low refractive index material. The refractive index of the impedance matching portion 216B is between about 1.4 and about 2.0. The impedance matching portion 216B includes, but is not limited to, materials containing silicon nitride, silicon oxide, aluminum oxide, or combinations thereof. In one embodiment, which can be combined with other embodiments described herein, the device portion 216A is silicon nitride and the impedance matching portion 216B is silicon oxide. In some embodiments, the impedance matching portion 216B corresponds to a hard mask layer utilized for waveguide fabrication. The materials of the hard mask layer are selected such that the patterned hard mask layer remains as the impedance matching portion 216B. As different materials and combinations of material may be realized in the device structures, different designs of the waveguide 100 can be achieved.

In some embodiments, which can be combined with other embodiments described herein, the anti-reflective portion 216C is an etch stop layer. The anti-reflective portion 216C is an etch stop layer that remains after formation of the plurality of devices structures 102. The anti-reflective portion 216C is an etch stop layer when the anti-reflective portion 216C is fully etched through or not etched at all. The refractive index of the anti-reflective portion 216C is between about 1.4 and about 2.0. The anti-reflective portion 216C includes, but is not limited to, materials containing silicon nitride, silicon oxide, aluminum oxide, or combinations thereof.

The ability to impedance match the impedance matching portion 216B to the device portion 216A as well as impedance match additional portions of the device structures 102 improves the anti-reflection capabilities of the plurality of device structures 102. In some embodiments, to determine the refractive index of the impedance matching portion 216B, a first impedance matching formula may be used. The first impedance matching formula is:

N2≈(N1×N3)^{0.5}

where N1 is the refractive index of the device portion 216A, N2 is the refractive index of the impedance matching portion 2166, and N3 is the refractive index of air (or another medium surrounding the waveguide 100). In some embodiments, which can be combined with other embodiments described herein, the refractive index of the anti-reflective portion 216C is determined with a second impedance matching formula. The second impedance matching formula is:

N_{anti-reflective}≈(N_{substrate}×N1)^{0.5}

where N1 is the refractive index of the device portion 216A, N_{anti-reflective} is the refractive index of the anti-reflective portion 216C, and N_{substrate} is the refractive index is the substrate refractive index. Based on the impedance matching formulas, the materials of the plurality of portions 216 may be chosen to improve the impedance matching within the waveguide 100.

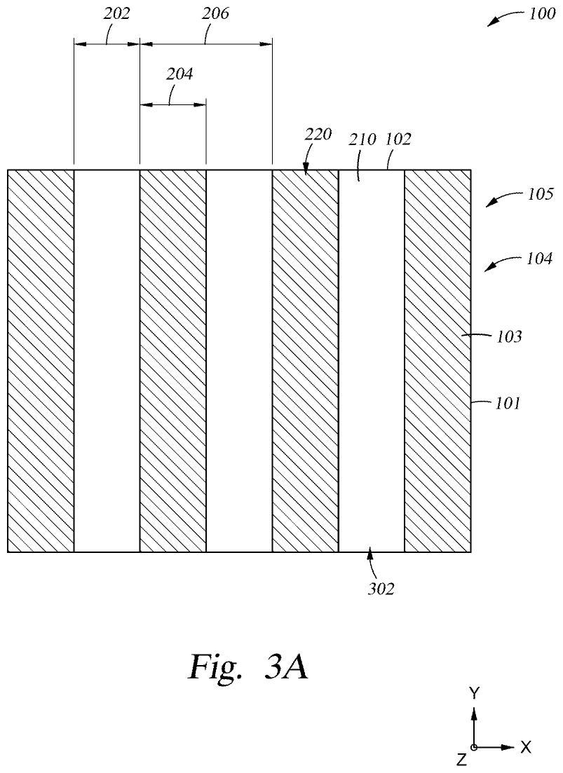

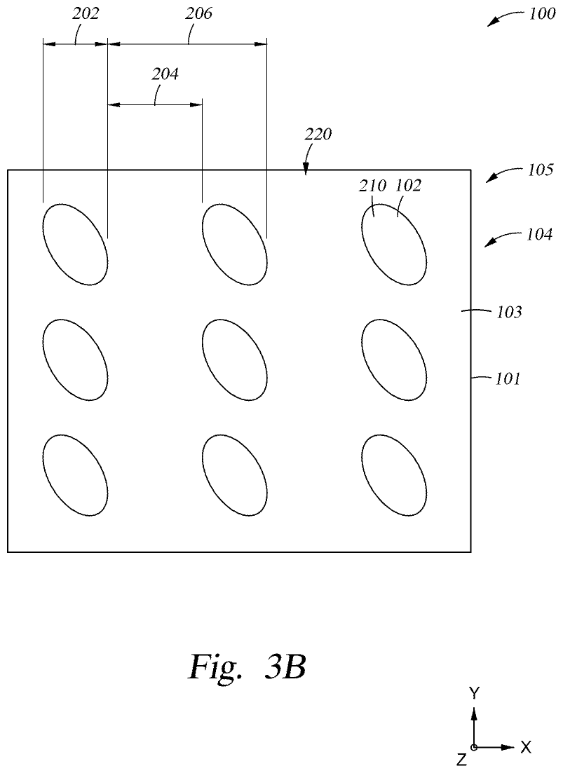

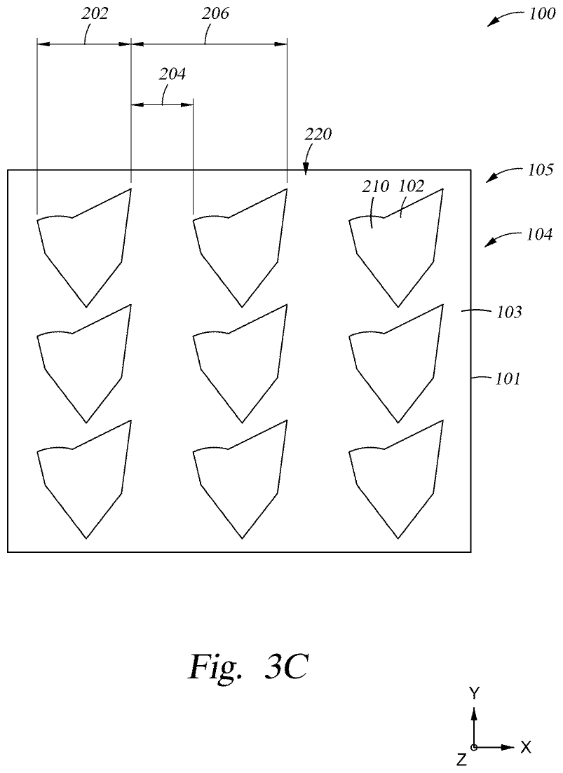

FIGS. 3A-3C are schematic, top-views of a portion 105 of a grating 104 of a waveguide 100. The grating 104 includes a plurality of device structures 102. The plurality of device structures 102 are disposed on a top surface 103 of a substrate 101. Each of the device structures 102 includes an upper surface 210. Each of the plurality of device structures 102 have a plurality of portions 216 (shown in FIGS. 2A-2C).

As shown in FIG. 3A, the plurality of device structures 102 are fin structures. The fin structures are disposed in parallel rows 302. Although the plurality of device structures 102 in FIG. 3A depict a rectangular cross-section, the device structures 102 are not limited in the cross-section shape. As shown in FIG. 3B, the plurality of device structures 102 may be discrete device structures 102. Each device structure 102 is adjacent to other device structures 102 in both the first direction and the second direction, wherein the first direction is perpendicular to the second direction. For example, the plurality of device structures 102 are disposed along an x-direction and a y-direction, as illustrated in FIG. 3B, such that the plurality of device structures 102 are each disposed only along the first direction and the second direction. Although the plurality of device structures 102 in FIG. 3B depict an oval cross-section, the device structures 102 are not limited in the cross-section shape. As shown in FIG. 3C, the plurality of device structures 102 may be discrete device structures 102. Each device structure 102 is adjacent to other device structures 102 in both the first direction and the second direction, wherein the first direction is perpendicular to the second direction. The plurality of device structures 102 in FIG. 3C are not limited to the cross-section shown in FIG. 3C. For example, the cross-section of the plurality of device structures 102 may be any shape operable to support multiple layers of waveguides 100 formed thereon.

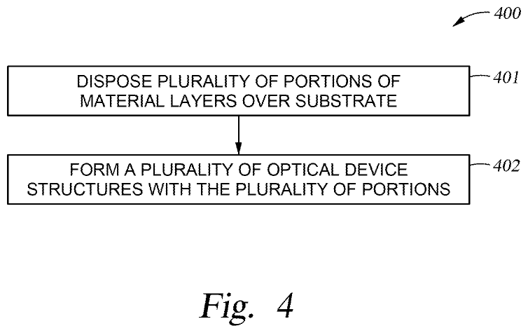

FIG. 4 is a flow diagram of a method for forming a waveguide having multiple portions of materials according to embodiments described herein. To facilitate explanation, the method 400 is explained with reference to the plurality of device structures 102 shown in FIGS. 2A-2C, however it is contemplated that the method 400 may be performed to form any shaped device structure 102.

At operation 401, a plurality of layers of material are disposed over a substrate 101. Each of the plurality of portions 216 of material are disposed using a liquid material pour casting process, a spin-on coating process, a liquid spray coating process, a dry powder coating process, a screen printing process, a doctor blading process, a PVD process, a CVD process, a FCVD process, a PECVD process, magnetron sputtering, ion beam sputtering, electron beam evaporation, or an ALD process. Each layer of material is chosen such that impedance matching (e.g., anti-reflection) will occur between the layers of material to improve the ant-reflective properties of the device structures 102 to be formed. The layers of material include a device material and an impedance matching material.

Each of the layers has a thickness 218 chosen to improve the diffractive efficiency of the waveguide 100 to be formed. The material of each layer and the thickness 218 of each layer is determined via optical simulation to improve the diffractive efficiency and to improve anti-reflective capabilities. The optical simulation can be performed based on electromagnetic simulation approaches including, but not limited to, finite-difference time-domain (FDTD), finite-difference frequency-domain (FDFD), rigorous coupled-wave analysis (RCWA), or finite element analysis (FEM). In the optical simulations; the size and positioning of the plurality of device structures 102 as well as the refractive index of each of the portions 216 may be altered to improve the waveguide 100 performance.

At operation 402, a plurality of device structures 102 are formed. Etching one or more of the plurality of layers forms the plurality of device structures 102 having a plurality of portions 216 of the layers. The plurality of device structures 102 are formed with one or more of a nanoimprint lithography, nanoimprint process, optical lithography, ion-beam etching, reactive ion etching, electron beam etching, or wet etching process, or combinations thereof. A device portion 216A of a device material and an impedance matching portion 216B of an impedance matching material may be formed.

In some embodiments, which can be combined with other embodiments described herein, the impedance matching portion 216B of the plurality of portions 216 is a hard mask layer. For example, the operation 402 may include the impedance matching portion being partially etched to form a hard mask layer. The partially etched impedance matching portion 216B can define the plurality of device structures 102 to be formed in a device portion 216A and the impedance matching portion 216B. The impedance matching portion 216B remains one of the plurality of portions 216.

In other embodiments, an anti-reflective portion 216C is disposed between the substrate 101 and the device portion 216A. The anti-reflective portion 216C is an etch stop layer. For example, the operation 402 can include etching the etch stop layer through openings formed in the device portion after etching the device portion. The anti-reflective portion 216C remains one of the plurality of portions 216.

As the plurality of device structures 102 are formed with a single etch operation, additional operations, such as depositing an anti-reflective layer or a hard mask layer do not need to be completed as one or more of the portions 216 may serve as an anti-reflective layer or a hard mask layer. Thus, fabrication costs may be reduced.

In summation, waveguides having device structures with multiple portions and methods of forming the waveguide having multiportion device structures are described herein. The plurality of device structures are formed having two or more portions. The materials of the plurality of portions are chosen such that impedance matching is enabled between the portions to reduce reflection of light from the optical device. The impedance matching allows for the device structures to couple light more efficiently. As the material of the plurality of portions are not disposed in gaps in-between the plurality of device structures, the refractive index contrast between the materials of the device structures and the surrounding air is not affected. Forming the multi-portion device structures with a single etch step will reduce fabrication costs.

While the foregoing is directed to embodiments of the present disclosure, other and further embodiments of the disclosure may be devised without departing from the basic scope thereof, and the scope thereof is determined by the claims that follow.

What is claimed is:

1. A waveguide, comprising:
an optical device substrate; and
at least one grating disposed over the optical device substrate, the at least one grating having a plurality of device structures, adjacent device structures of the plurality of device structures defining a gap therebetween, the plurality of device structures having:
a device portion, the device portion including a device material having a first refractive index of about 1.9 to about 4.0; and
an impedance matching portion, the impedance matching portion having a second refractive index of about 1.4 to about 2.0.

2. The waveguide of claim 1, wherein the plurality of device structures correspond to an input coupling grating or an output coupling grating.

3. The waveguide of claim 1, wherein a difference between the first refractive index and the second refractive index is about 0.45 to about 1.15.

4. The waveguide of claim 1, wherein the plurality of device structures are disposed with a device angle ϑ between about 10 degrees and about 170 degrees.

5. The waveguide of claim 1, wherein the device material includes materials containing germanium, silicon, titanium oxide, niobium oxide, silicon nitride, hafnium oxide, tantalum oxide, scandium oxide, or combinations thereof.

6. The waveguide of claim 1, wherein the impedance matching portion includes impedance matching materials containing silicon nitride, silicon oxide, aluminum oxide, or combinations thereof.

7. The waveguide of claim 1, wherein the impedance matching portion is a hard mask layer.

8. The waveguide of claim 1, wherein the plurality of device structures further includes an anti-reflective portion disposed between the device portion and the optical device substrate, wherein the anti-reflective portion is an etch stop layer.

9. The waveguide of claim 1, wherein the second refractive index falls in a range produced by an impedance matching formula, wherein the impedance matching formula is: N2≈(N1×N3)^{0.5}, wherein N2 is the second refractive index, N1 is the first refractive index, and N3 is a refractive index of air or a surrounding medium.

10. A waveguide, comprising:
an optical device substrate; and
at least one grating disposed over the optical device substrate, the at least one grating having a plurality of device structures, adjacent device structures of the plurality of device structures defining a gap therebetween, the plurality of device structures having:
a device portion, the device portion including a device material having a first refractive index of about 1.9 to about 4.0;
an impedance matching portion having a second refractive index of about 1.4 to about 2.0; and
an anti-reflective portion having an anti-reflective refractive index of about 1.4 to about 2.0, wherein a difference between the first refractive index and at least one of the second refractive index or the anti-reflective refractive index is about 0.45 to about 1.15.

11. The waveguide of claim 10, wherein the plurality of device structures are discrete optical device structures.

12. The waveguide of claim 11, wherein the adjacent device structures are adjacent to other device structures in both a first direction and a second direction, wherein the first direction is perpendicular to the second direction, such that the plurality of device structures are each disposed only along the first direction and the second direction.

13. The waveguide of claim 10, wherein the plurality of device structures are fin structures, wherein the fin structures are disposed in parallel rows.

14. The waveguide of claim 10, wherein the impedance matching portion is a hard mask layer.

15. The waveguide of claim 10, wherein the anti-reflective portion is an etch stop layer.

16. The waveguide of claim 10, wherein the second refractive index falls in a range produced by an impedance matching formula, wherein the impedance matching formula is: N2≈(N1×N3)^{0.5}, wherein N2 is the second refractive index, N1 is the first refractive index, and N3 is a refractive index of air or a surrounding medium.

17. The waveguide of claim 10, wherein the plurality of device structures are disposed with a device angle ϑ between about 10 degrees and about 170 degrees.

18. A method, comprising:
disposing two or more layers of material on a surface of a substrate; and
etching through the two or more layers of material to form a plurality of device structures having two or more portions, wherein the two or more portions include:
a device portion having a first refractive index of between about 1.9 and about 4.0; and
at least one of an impedance matching portion or an anti-reflective portion, the impedance matching portion or the anti-reflective portion having a second refractive index of about 1.4 to about 2.0, wherein a difference between the first refractive index and the second refractive index is about 0.45 to about 1.15.

19. The method of claim 18, wherein the two or more layers of material are disposed with a PVD process or a CVD process.

20. The method of claim 18, wherein the plurality of device structures are formed with one or more of ion-beam etching, reactive ion etching, or electron beam etching, or combinations thereof.
